(19) United States
(12) Patent Application Publication
(10) Pub. No.: US 2004/0110870 A1
(43) Pub. Date: Jun. 10, 2004

(54) Fire protection coating composition

(76) Inventor: Matthew T. Liu, Slidell, LA (US)

Correspondence Address: Bruce M. Winchell, 13324 Sunset Canyon Drive NE, Albuquerque, NM, 87111-4250, US

(21) Appl. No.: 10/309,493

(22) Filed: Dec. 4, 2002

(51) Int. Cl. B05D 3/00; C09K 21/14

(52) U.S. Cl. 523/179; 427/299

(57) ABSTRACT

The present invention relates to a fire protection coating composition and method of using same on substrate materials for which some degree of fire protection from intense heating and fire is necessary or desirable. The fire protection coating composition will expand upon being exposed to fire or intense heating to provide a protective layer for the substrate material for which protection is required.

### BACKGROUND OF THE PRESENT INVENTION

The present invention relates to a coating composition for materials for which some degree of fire protection is necessary or desirable. More particularly, the invention provides a fire protection coating composition that will expand upon being exposed fire or intense heat to provide a protective layer for the substrate material for which protection required. The present invention relates to a new and useful fire protection coating composition which can protect various substrate materials from flame spread and intense heat that can destroy substrate materials for minimum times of 1.5 hours which exceeds most current fire codes for fire protection to improve safety and health of people and property in the area of a fire or intense heating of the area.

Fire safety and protection of lives and structures from fire have become a major consideration of the construction industry. Fire and smoke sensors, water sprinklers, and other devices have become standard requirements of design and construction in recent years. Similarly, architectural specifications of steel based structures now specify the requirement for fire protective coatings to the steel structural members in order to preserve the integrity of the structure in the event of fire. While fire retardant coatings or paints have been used for many years in such applications, recent advances in coatings and paints technology have afforded much improved protective characteristics, particularly with respect to intumescent coatings and paints. The performance of intumescent coatings is based on the balance and efficiency of three related mechanisms.

The first of these are the char formers, the characteristics and strength of char produced from the pyrolized coating or paint. The second of these are the blowing agents. Blowing or expansion agents that upon heating release controlled, nontoxic, incombustible gases that expand the pyrolized coating/paint film. The third of these are the catalysts, such as organic dehydrating agents that balance and promote char formation. U.S. Pat. No. 5,968,669 is and example of the char forming type with blowing agents included.

Early fire protection systems for construction materials often involved impregnating the building product with a flame-retardant chemical, such as mono-ammonium phosphate or phosphoric acid. These chemicals react with the wood in the presence of heat so that the wood forms a char layer. The char provides a protective layer that insulates the underlying wood and prevents oxygen from reaching the underlying wood. However, these treatments have several drawbacks. The formation of the char weakens wood. The phosphates may leach out of the wood with time, reducing the effectiveness of the treatments. These treatments have been known to cause premature thermal degradation of wood in the presence of heat from a source such as solar radiation, which can lead to the failure of a structure made from treated wood. For steel often the treatment consisted of a coating of asbestos glued to the structural members to reduce the temperature actually affecting the steel members and thus reducing failure rates for such steel members. The chief problem with these coatings was the toxicity of asbestos.

A more recent approach includes spraying plastic foams onto the structural members to provide insulation for the members from the heat of a fire. For combustible structural members such foams would have to have a flame retardant. These foams also have several drawbacks. The phosphates in the coatings are expensive, and significantly increase the cost of building materials treated with the coatings. The char layer may be too thin to insulate the underlying structural member well enough to prevent damage or weakening of the structural member. Many of these coatings have insufficient expansive strength to expand when covered by paint or other coatings.

Another type of intumescent coating is that of U.S. Pat. No. 6,084,008 which uses a graphite-based substance known as expandable graphite to protect the underlying structural member material from fire. Expandable graphite is produced by intercalating a material that decomposes into a gas when heated into the crystal lattice of ordinary graphite. When the coating is heated to the decomposition temperature of the intercalate, the gasses produced push apart the layers of the graphite, expanding the coating and producing an insulating layer over the structural member.

Coating with expandable graphite typically expand to a greater degree than other intumescent coatings, and thus provide superior insulation to the underlying material. However, known expandable graphite coatings also have drawbacks. These coatings often exhibit the “popcorn effect”, where the expansion of the grains of the graphite cause the grains to pop off the surface of the underlying material. The expanded graphite is weak and brittle, and may be blown off of the underlying material by the turbulent winds produced in a fire condition. A binder is typically used to prevent the popcorn effect and to hold the expanded coating together. However, many binders are flammable, and thus may counteract the flame-retardant properties of the coating.

Another example of a more recent coating composition for use in treating wood is U.S. Pat. No. 6,245,842 which provides a flame-retardant intumescent coating for a wood-based building product, the coating being adapted to expand to form an expanded coating when exposed to heat from a fire. The coating comprises a polymeric binder, at least one blowing agent dispersed in the binder, and at least one intumescent compound dispersed in the binder. The blowing agent and intumescent compound are adapted to expand the coating when the coating is exposed to heat from a fire. The polymeric binder is formed from a mixture including castor oil and an isocyanate, wherein the castor oil is present in the mixture in a quantity of 9-36% of the total weight of the coating. The composition comprises a mixture of a dry component and a curable component. The dry component includes expandable graphite, vermiculite and at least one blowing agent, and comprises between 35% and 70% of the mixture by weight. The curable component includes castor oil and at least one isocyanate.

This coating composition however has drawbacks. This coating composition is mainly a flame retardant material for use with wood. It lacks the primary adhesive requirements for steel structural members and it uses solvents which cause environmental problems thus not meeting some of the environmental requirements of today for such materials. Such requirements also show up in standard architectural specifications today.

### SUMMARY OF THE PRESENT INVENTION

The fire protection coating composition of the present invention overcomes these deficiencies of the prior art discussed above while enhancing many other desirable characteristics for a fire protection coating composition.

It is an object of the present invention to protect various types of substrate materials from fire and/or intense heating by coating a substrate with coating compositions by methods that provide significant protection against fire and/or intense heating.

It is an object of the present invention to provide a fire protection coating composition which expands when exposed to intense heat and/or flames to create a char foam to protect the underlying substrate member such as wood, steel and other substrate materials to which it is applied from the problems associated with heat build up and consumption by fire.

It is a another object of the present invention to provide a fire protection coating composition that does not emit noxious gases, acid vapor, or undesirable levels of smoke when exposed to heat and flames which cause environmental problems and human health problems.

It is further object of the present invention to provide a fire protection coating composition to meet environmental concerns, environmental requirements enacted today and standard architectural specification requirements of today for application and use of such coating compositions.

In accordance with the illustrative preferred embodiments and demonstrating features of the present invention, there is provided by the present invention, a fire protection coating composition having a thick and strong char foam forming characteristic when exposed to intense heat and/or flame. The fire protection coating composition of the present invention has a slow flame spread characteristic. The fire protection coating composition of the present invention has a low smoke density. The fire protection coating composition of the present invention has a non toxic emissions upon char foaming thus meeting human health, environmental and architectural specification requirements for the application and use of such coating compositions.

These and other objects, features and advantages of the present invention will be readily apparent to those skilled in this art from the following detailed description of preferred embodiments of the present invention.

### DETAILED DESCRIPTION OF THE PREFERRED EMBODIMENTS

The present invention is a latex based, high solid content, thin film fire protection coating composition and method of using such coating compositions on substrates of various materials, which is applied with the ease of a conventional paint. Unlike conventional fire proofing, the fire protection coating compositions of the present invention are applied with minimum thickness and require no additional reinforcement. The fire protection coating composition of the present invention meets all of the strictest volatile organic compound requirements, and minimizes human health risks in the event of a fire and/or intense heating of such substrate materials to significantly enhance public safety. The fire protection coating compositions of the present invention dries quickly to a flat matte finish, having the appearance of a conventional flat paint or a semigloss paint. Under intense heat and/or flame sources, the coating swells/foams, foaming a thick, dense, uniform, tough, sponge-like charred cellular foam between the flame and the substrate. This charred foam layer insulates the substrate beneath, reducing the penetration of heat/flame, thus retarding the flame spread preserving the structural integrity of the substrate material or prolonging the structural deformation or collapse. The fire protection coating composition and methods of use thereof, can be applied to most any material commonly used in the construction of buildings to significantly add to public safety from fire and intense heating of such substrate materials.

Fire protection capability of the fire protection coating composition of the present invention can be appreciated by the following simple demonstration. One single brush-application of 8-10 mil dry film thickness of the fire protection coating composition of the present invention was applied to a cardboard panel will protect the panel against intensive torch flame (i.e. propane fuel flame of 1100-1150° F. Temperature) for more than two minutes without catching on fire.

The fire protection coating composition of the present invention can expect a service life of more than 20 years for indoor environments when properly applied. Although, the fire protection coating composition of the present invention was not specifically designed for outdoor applications, it can provide a service life of 5 to 10 years, depending on environmental conditions.

The fire protection coating composition of the present invention is designed to protect interior, exposed steel structural members i.e. beams, columns, struts, bulk heads etc. from intense heating and fire hazards. It is also used on interior surfaces such as wood, wallboard, plastics, particle board, paneling, etc., where it is either necessary or essential to reduce the surface burning characteristics of the structure or substrate materials. Typical applications of the fire protection coating composition of the present invention can include: housing, commercial buildings of all types, chemical plants, parking garages, petroleum refineries, aircraft hangars, oil rigs/platforms, atriums, food processing plants, stadiums/coliseums, warehouses, school gymnasiums, hospitals, correction facilities, power generation facilities and manufacturing facilities.

The advantages of the fire protection coating composition according to the present invention include: low cost; environmentally friendly; excellent fire protection properties; easily maintained; durable; easily applied; excellent adhesion to many different types of substrate materials; easily cleaned up; excellent impact resistance of the fire protection coating composition; user friendly and user familiar application methods; high build of over 120 mils dry film thickness can be achieved with one single application; and can be used as primer/undercoat rendering subsequent flammable top coat non-burning.

A typical fire protection coating composition according to the present invention can be made by a blending together of ingredients for the coating composition using the following typical ingredients for the fire protection coating composition of the present invention.

Fire protection coating compositions of the present invention include a char forming material such as: a starch, a sugar, molybdenum, antimony trioxide, organometallocenes, a mono pentaerythritol, a dipentaerythritol or a tri pentacrythritol. One such material is PE-200 made by U.S. Chemical Corp. These materials are important because the dynamics of forming the char consumes heat and these chars form an insulative barrier to the intense heat that would damage the substrate material such as by weakening the substrate material. Such weakening is very damaging for structural members such as in a building.

Fire protection coating compositions of the present invention include a char reinforcement material such as: a glass flake, a glass fiber, a silica fiber, a silica powder or a fumed silica. Such materials provide a structural integrity to the char foam once it has been formed and these materials will not burn. They have high melting temperatures and they absorb heat. They will not support flame. These materials can provide significant heat absorbing capacity and insulate the substrate material from the heat as well as retard flame spread which is important in saving the substrate material from the effects of fire. One such material is Aerosil 200 made by Degussa.

Fire protection coating compositions of the present invention include a catalyst or accelerator material such as: urea phosphate, melamine phosphate, mono basic ammonium polyphosphate, di-basic ammonium phosphate, hemi basic ammonium phosphate, or a urea ammonium phosphate. One such material is AP-422 made by La Roche Industries. These materials are important to the formation of the polymeric material that form the basis of the char foam.

Fire protection coating compositions of the present invention include a blowing agent to produce inert gases which do not support flame and serve as an additional insulative barrier to the spread of heat to the substrate material. Blowing agents include: urea, p-toluene sulfonyl hydrazide, azodicarbonamide, cyanoguanidine, dicyandiamide, diaminophenazine, borax, zinc carbonate, and chlorinated paraffins. Such materials are cyanurotriamide made by Allchem Industries, Inc., Chlorowax 70L made by Oxychem Corporation, and Celogen TSH made by Uniroyal Chemical Company.

Fire protection coating compositions of the present invention include a binder that is thermoplastic in nature and can be a homo polymer, a copolymer, or a polymer hybrid in the form of a solution, emulsion or a dispersion. Such materials include: acrylics, vinyl acrylics, vinyl chloride-ethylene copolymers, chlorosulfonated polyethylene, polyvinylidene chloride, vinyl toluene-acrylic or acrylate copolymers, ethylene vinyl chloride, vinyl acetate-vinyl chloride-ethylene terpolymers, vinyl acetate-vinyl chloride copolymers, modified alkyds, urethane-acrylic copolymers, and cellulose ethers. Materials which belong to this class include: Flexbond 381, Airflex 4514, and Hybridur 540, all made by Air Products & Chemicals Co. Also, others material in this class include: Rhoplex HA12 made by Rhom and Haas Corporation and Resin 57-5747 made by Cargill Corporation.

Fire protection coating compositions of the present invention include a pigment that will make the fire protection coating compositions of the present invention more pleasing to the eye as well as support the composition such as: titanium dioxide, barium sulfate, mica, calcium carbonate, iron oxide, zinc oxide, clay, kaolin, or calcium sulfate.

Fire protection coating compositions of the present invention include a surfactant or wetting agent such as: Silwet L790 made by OSI; Triton N57, Triton X45 and Tamol 165 made by Rohm & Haas; F430 made by 3M; Polywet 35 made by Uniroyal; Antiterra 204 made by BYK Chemie; and Surfynol 485W and Surfynol 104 made by Air Products & Chemical.

Fire protection coating compositions of the present invention include a thickener such as: Acrysol-R made by Rohm & Haas; Bentone EW and Thixatrol 789 made by Rheox; Celite 499 made by Celite; Optigel LX made by Sud Chemie; hydroxy ethyl cellulose made by Hercules Chemical Company; Carbopol 941 made by B.F. Goodrich Company; Nuvis HS made by Hercules Corporation; Tafigel 45 made by Kings Industries; and Flowrone ST made by Southern Clay.

Fire protection coating compositions of the present invention include a defoamer or antifoam agent such as: Disparlon ox-6 made by King Industries; Coat-o-sil 1378 made by OSI; BYK022 made by BYK Chemie; DeeFo 3000 made by Ultra Additives; EFKA-27 made by Rheox; A Compound made by Dow Corning; Tego 1488 made by Tego Chemicals; Silwest L7500 made by Osi; or Surfynol DF58 made by Air Products & Chemical Company.

Fire protection coating compositions according to the present invention include a solvent such as water. When water is used as the solvent in the fire protection coating composition of the present invention, then the resulting fire protection coating composition meets the volatile organic compound requirements in force presently in all states of the United States. Use of water as the solvent also significantly adds to public safety to minimize human health risks in the event of an intense heating or fire event of the resulting fire protection coating composition of the present invention applied in accordance the methods of the present invention.

The best mode for carrying out the methods of use and the fire protection coating composition of the present invention can be best illustrated by the following examples of a fire protection coating composition according to the present invention. The best method of using the fire protection coating composition of the present invention in a fashion that meets the best and most strict requirements for volatile organic compounds and human health requirements in the United States is best illustrated by using the methods described herein for the application and use of these fire protection coating compositions of the present invention to attain the fire protection while meeting environmental requirements to minimize human health risks in the event of an intense heating or fire event.

Three examples of a fire protection coating composition according to the present invention are provided herein below.

### EXAMPLE 1

| | Weight Percent |
|---|---|
| Ingredient | of the Total |
| Water | 25.12 |
| Flexbond 381 | 17.92 |
| Propylene glycol | 0.90 |
| Urea | 5.93 |
| Titanium dioxide | 2.85 |
| Chlorowax 70L | 8.77 |
| AP 422 | 10.78 |
| Cyanurotriamide | 2.37 |
| PE200 | 20.00 |
| Dicyandiamide | 3.56 |
| Surfactant N57 | 0.50 |
| Coat-o-sil 1738 | 0.40 |
| Aerosil 200 | 0.60 |
| Bentone EW | 0.30 |

### EXAMPLE 2

| | Weight Percent |
|---|---|
| Ingredient | of the Total |
| Water | 26.44 |
| HA12 | 22.40 |
| Propylene glycol | 1.14 |
| Chlorowax 70L | 2.68 |
| Urea | 4.82 |
| Titanium dioxide | 3.56 |
| PE200 | 20.08 |
| Borax | 16.73 |
| Surfynol 104 | 0.45 |
| EFKA 27 | 0.50 |
| Fumed Silica M5 | 0.80 |
| Natronol 250 | 0.40 |

### EXAMPLE 3

| | Weight Percent |
|---|---|
| Ingredient | of the Total |
| Hybridur 540 | 21.65 |
| Water | 20.67 |
| Propylene glycol | 2.66 |
| Chlorowax | 4.15 |
| Urea | 3.86 |
| Titanium dioxide | 2.85 |
| Calcium carbonate | 2.85 |
| P-toluene sulfonyl hydrazide | 3.60 |
| PE200 | 28.92 |
| Borax | 7.27 |
| Surfynol 485W | 0.45 |
| BKY 024 | 0.32 |
| Aerosil 200 | 0.50 |
| Tafigel 45 | 0.25 |

These examples of the fire protection coating composition were applied as a paint to a substrate in accordance with the following suggested application requirements and then tested in accordance with the described testing standards set forth here in.

The surface preparation is similar to that for any surface to be painted with usual paints or other commonly used coating compositions. Typical good painting surface preparation practices are sufficient for fire protection coating composition of the present invention. All surfaces should be clean, free of oil, grease, fuels and other foreign matter such as metallic oxides. Metal surfaces should be primed after being prepared, prior to application of the fire protection coating composition of the present invention.

The fire protection coating composition of the present invention is formulated in sprayable and heavy bodied mastic grades. Suitable application methods include spray, brush, roller and troweling/spreading such as the applying of a stucco material to the outside of a building structure. For the most uniform coating, spray application is recommended. Spray application is performed using heavy duty, industrial spray coating equipment. For fire protection of structural steel, coating thickness of 120 mils is recommended to provide a minimum 1.5 hours of fire protection. For a high degree of fire protection to other substrates, coating thickness of 18-20 mils has been utilized. Multiple coats of the fire protection coating composition of the present invention may be required to meet the required protective thickness. Previous coats should be allowed to dry prior to re-application; 2 to 3 hours under typical temperature and humidity conditions.

Once applied to the desired thickness, the fire protection coating composition of the present invention should be allowed to dry thoroughly prior to top coating. Once dry, the fire protection coating composition of the present invention can be top coated with any standard commercial paint; water based, oil based, solvent based, or 100% solids top coats. Cleaning of applicators and equipment used in the application of the fire protection coating composition of the present invention can be accomplished with soap and water.

While the fire protection coating of the present invention is designed for protection of structural steel, it has been utilized for thermal protection of various other substrates. As an example, one roller application of 10 to 12 mils dry film thickness of the fire protection coating composition of the present invention applied to a wood panel has protected the panel from burning when exposed to an intense propane torch for over 4 minutes. Thus, in addition to protection of structural steel, fire protection coating composition of the present invention can be utilized to improve the fire resistance of flammable materials such as wood, wallboard, etc. It can also be used as a temporary protectant to surrounding surfaces of high heat operations such as welding, torch cutting, etc. Suitability and performance of fire protection coating composition of the present invention in extended applications would need to be evaluated and tested by the end user.

This product would should be offered for sale and use to mainly professional contractors or applicators who are experienced in this type of work. Such professional users would of course always observe all health and safety precautions as listed on the Material Safety Data Sheet (MSDS) during storage, handling, application, drying and disposal of such materials to avoid health and safety issues found to exist with the use of such materials. In general, standard painting safety precautions should be followed. Respiratory protection should be utilized to avoid inhalation of spray mist.

Physical Characteristics

Common physical characteristics of the Example 1 fire protection coating composition include:

COLOR: Low gloss white
COVERAGE: 670/gallon (theoretical). For estimation purposes, 1 gallon
will cover 32 square feet with an 18-20 mil Dry Film Thickness,
assuming a loss factor of 20 percent.
BASIC DATA: at 78 +/− 1 degree Fahrenheit

| Property | Value |
|---|---|
| Mass density, lbs/gallon | 11.0 +/− 0.2 |
| Solid content, % | 65.0 +/− 0.5 |
| Dry to touch time, minutes | 45 |
| Dry hard time, hour | 3 |
| Recoating/over coat time | 2 to 3 |
| in hours | |
| Shelf life, month | >12 |
| Flash point, ° F. | N/A |
| Cleaning solution | soap and water |

PROPERTIES: at 78+/−3 degrees Fahrenheit

| Property | Test Method | Result/Comment |
|---|---|---|
| Grind size | GB 1603 | <1.0 mil, Good |
| Adhesion | GB 1720 | Class 3, Pass |
| Flexibility | GB 1731 | 1/4″, Excellent |
| Impact strength | GB 1732 | 40 kg-cm, Excellent |
| Flamability | ZBG 51003 | Class A, Excellent |
| | (ASTMD 1360) | |
| Burning test | Gas flame 38 mil Dry | >680 mil char, Excellent |
| | Film Thickness | |
| Weight loss | ZBG 51003 | 4.1 gm, Excellent |
| | (ASTMD 1630) | |
| Flame resistant | 2 minutes torch | No burn through, Excellent |
| | (8 mils Dry Film | |
| | Thickness coated | |
| | cardboard) | |
| Application | One application of | No cracks, Excellent |
| | 120 mil Dry Film | |
| | Thickness upon drying | |

To obtain the best results applying the fire protection coating composition of the present invention the application process instruction for the fire protection coating composition of the present invention should include the following elements.

Surface Preperation

Surface to be painted must be properly prepared in accordance with good painting practices. For wood substrates, wall board, acoustical tile, and plastic substrate materials, remove all dirt, grease, oil and any loose matters prior to painting. Oil and grease can be removed with a cleaning solution such as a commercial emulsifying cleaner followed by water or wiping with clothe/rag dampened with water. Dirt and dust can be removed with vacuum cleaner, clean bristle brush or by blowing with dry, clean, compressed air.

For metallic substrates, remove all rust or other oxide surface materials, scale, and any loose matters by abrasive blasting or power tool cleaning. Power tool used shall be pneumatic driven or electric. The compressed air used to drive such tools must be free from oil and water. Dust or vacuum off residues. Wipe all surfaces down with rags dampened with the cleaning solution. The surface should then be primed with an anti corrosion primer to protect the steel structure against corrosion. A urethane modified epoxy based anti corrosion primer or its equivalent epoxy based material is recommended for used with the fire protection coating composition of the present invention. For product information and application instruction refer to the primer literature furished by the manufacturer.

Application Method

The fire protection coating composition of the present invention can be made available in both standard viscosity and mastic grades. The standard viscosity grade fire protection coating composition of the present invention is brushable, rollable, and sprayable. When the fire protection coating composition of the present invention is applied with brush/roller, use high quality brush/roller. Brush/roller application is recommended for small jobs and repairs. When spray method is adopted for the application, spray equipment shall be thoroughly cleaned and the hose, in particular, shall be free of old paint particles and any foreign matters for a high quality paint job. Bink's spray gun, model 7 (with tip size of 36 and nozzle size of 36) or its equivalent is recommended for spray coating with the fire protection coating composition of the present invention. Spray equipment should be cleaned upon completion of spray operation with soap and water.

The mastic grade application method for the heavy bodied mastic form of the fire protection coating composition of the present invention should be applied with the help of a trowel. A dry film thickness of more than 120 mils can be achieved with one single application without the mud cracking when dry. However, the mastic grade of the fire protection coating composition of the present invention can also be spray applied. For the spray application, a heavy duty pneumatic operated positive action pump is recommended. A power ratio of at least 45:1 is suggested. These pumps are air operated requiring no electrical source. Spray unit, model No. 218-335, 45:1 made by Grasco or its equivalent is recommended for spraying the mastic grade of the fire protection coating composition of the present invention. It is important to make a test application to familiar oneself with the spray unit, process and technique required.

Coating Thickness Recommendation

Dry film thickness of the application will depend on the fire endurance per specified. The fire protection coating composition of the present invention should be applied by qualified, factory trained applicators. For high degree of fire protection, the recommend coating thickness of 18-20 mils is preferred. However, for protection of steel structures, a coating thickness of 120 mils is suggested in order to achieve a minimum of 1.5 hours direct fire exposure.

Over Coating/Top Coating

Over coat is not required with the fire protection coating composition of the present invention. However, if an over coating is required for decorative purposes, a high quality house paint, either oil based or latex in the market can be used without damage to the performance of the fire protection coating composition of the present invention. The fire protection coating composition of the present invention will be generally dry to touch in 45 to 60 minutes. It can be recoated in 2 to 3 hours depending on ambient humidity, temperature, and wet coating thickness.

Application Environmental Conditions

The fire protection coating composition of the present invention must be applied by trained applicators. Job site must be well ventilated with local exhaust. Since the fire protection coating composition of the present invention is water based it must be kept from freezing at all times, during, shipping, storage, application and drying. The fire protection coating composition of the present invention should not be applied when the ambient temperature is 40° F. and below. The fire protection coating composition of the present invention should not be applied onto substrate surfaces at temperatures 5° F. below dew point to prevent condensation on the surfaces. Care shall be taken to protect the coating from the rain for the first 48 hours of application.

While the fire protection coating composition of the present invention has been disclosed in its preferred embodiments, it is understood that the invention is not limited to the precise details of this disclosure contained herein, but may otherwise be embodied with its various changes, modifications and improvements which would occur to those skilled in this art, without departing from the scope of the invention as defined in these appended claims.

What is claimed is:

1. A fire protection coating composition comprising: (a) a char forming material selected from the group of: a starch, a sugar, a mono pentaerythritol, a di pentaerythritol, a tri pentaerythritol, molybdenum, organometallocenes, or antimony trioxide;
(b) a char reinforcement material selected from the group of: a glass flake, a glass fiber, a silica fiber, a silica powder, or a fumed silica;
(c) a catalyst or accelerator material selected from the group of: urea phosphate, melamine phosphate, di ammonium polyphosphate, a monobasic ammonium phosphate, di-basic ammonium phosphate, hemi-basic ammonium phosphate, or a urea ammonium phosphate;
(d) a blowing agent selected from the group of: urea, p-toluene sulfonyl hydrazide, dicyndiamide, azodicarbonamide, di aminophenizine, cyanurotriamide, cyanoguanidine, borax, zinc carbonate, and chlorinated paraffin.
(e) a binder selected from the group of: acrylics, vinyl acrylics, vinyl chloride-ethylene copolymers, chlorosulfonated polyethylene, polyvinylidene chloride, vinyl toluene-acrylic or acrylate copolymers, ethylene vinyl chloride, vinyl acetate-vinyl chloride-ethylene terpolymers, vinyl acetate-vinyl chloride copolymers, modified alkyds, urethane-acrylic copolymers, or cellulose ethers, that may be in the form of emulsion, dispersion, solution of hybrid;
(f) a pigment selected from the group of: titanium dioxide, barium sulfate, mica, calcium carbonate, iron oxide, zinc oxide, clay, kaolin, calcium sulfate, or talc;
(g) a surfactant or wetting agent selected from the group of: Silwet L790; Triton N57; Triton X45; F430; Polywet 35; Antiterra 204; Surfynol 485W and 104; or Tamol 165;
(h) a thickener selected from the group of: a sodium salt of polyacrylate; Acrysol-R; Bentone EW; Celite 499; Optigel LX; hydroxy ethyl cellulose; Carbopol 941; Nuvis HS; Tafigel 45; Natrsol 250, Flowrone ST; or Thixatrol 789;
(i) a defoamer or antifoarn agent selected from the group of: Disparlon ox-6; Coat-o-sil 1378; BYK022; DeeFo 3000; EFKA-27; A Compound; Tego 1488; Silwet 7500; or Surfynol DF58;
(j) water; and
(k) propylene glycol.

2. A fire protection coating composition according to claim 1, wherein the water equals a weight percentage of the total in the range of 10 to 35 weight percent.

3. A fire protection coating composition according to claim 1, wherein the catalyst or accelerator material equals a weight percentage of the total in the range of 8 to 16 weight percent.

4. A fire protection coating composition according to claim 1, wherein the binder material equals a weight percentage of the total in the range of 10 to 30 weight percent.

5. A fire protection coating composition according to claim 1, wherein the char former material equals a weight percentage of the total in the range of 10 to 30 weight percent.

6. A fire protection coating composition comprising: water, Flexbond 381, propylene glycol, urea, titanium dioxide, Chlorowax 70L, AP 422, cyanurotriamide, PE200, dicyandiamide, Surfactant N57, Coat-o-sil 1738, Aerosil 200, Bentone EW.

7. A fire protection coating composition according to claim 6, wherein the water equals a weight percentage of the total in the range of 10 to 35 weight percent.

8. A fire protection coating composition according to claim 6, wherein the AP422 equals a weight percentage of the total in the range of 8 to 16 weight percent.

9. A fire protection coating composition according to claim 6, wherein the PE200 equals a weight percentage of the total in the range of 10 to 30 weight percent.

10. A fire protection coating composition according to claim 6, wherein the Flexbond 381 equals a weight percentage of the total in the range of 10 to 30 weight percent.

11. A fire protection coating composition comprising: water, HA12, propylene glycol, Chlorowax 70L, urea, titanium dioxide, PE200, borax, Surfynol 104, EFKA 27, Fumed Silica M5, Natronol 250.

12. A fire protection coating composition according to claim 11, wherein the water equals a weight percentage of the total in the range of 10 to 35 weight percent.

13. A fire protection coating composition according to claim 11, wherein the HA12 equals a weight percentage of the total in the range of 10 to 30 weight percent.

14. A fire protection coating composition according to claim 11, wherein the PE200 equals a weight percentage of the total in the range of 10 to 30 weight percent.

15. A fire protection coating composition according to claim 11, wherein the Flexbond 381 equals a weight percentage of the total in the range of 10 to 30 weight percent.

16. A fire protection coating composition according to claim 11, wherein the borax equals a weight percentage of the total in the range of 5 to 20 weight percent.

17. A fire protection coating composition comprising: Hybridur 540, water, propylene glycol, Chlorowax 70L, urea, titanium dioxide, calcium carbonate, p-toluene sulfonyl hydrazide, PE200, borax, Surfynol 485W, BYK024, Aerosil 200, Tafigel 45.

18. A fire protection coating composition according to claim 17, wherein the water equals a weight percentage of the total in the range of 10 to 35 weight percent.

19. A fire protection coating composition according to claim 17, wherein the Hybridur 540 equals a weight percentage of the total in the range of 15 to 30 weight percent.

20. A fire protection coating composition according to claim 17, wherein the borax equals a weight percentage of the total in the range of 5 to 10 weight percent.

21. A fire protection coating composition according to claim 17, wherein the PE200 equals a weight percentage of the total in the range of 16 to 32 weight percent.

22. A fire protection coating composition according to claim 17, wherein the p-toluene sulfonyl hydrazide equals a weight percentage of the total in the range of 0.5 to 5 weight percent.

23. A method for protecting a substrate material from consumption by fire or significant damage by intense heat comprising the steps of: cleaning all surfaces of the substrate material to be free of oil, grease, fuels and other foreign matter such as oxides; applying a fire protection coating composition comprising; water, urea, propylene glycol, titanium dioxide, ammonium polyphosphate, mono pentaerythritol, cyanurotriamide, cyanoguanidine, Chlorowax 70L, Triton N57, Airflex 4514, Coat-O-Sil 1378, Aerosil 200 and Natrosol 250; and applying the fire protection coating composition to a dry film thickness in the range of 18 to 20 mils.

24. A method for protecting a substrate material from consumption by fire or significant damage by intense heat according to claim 23, wherein all metallic substrate surfaces are primed prior to application of the fire protection coating composition.

25. A method for protecting a substrate material from consumption by fire or significant damage by intense heat according to claim 23, wherein all metallic substrate surfaces are covered with the fire protection coating composition to a dry film thickness of 18 to 20 mils or more.

26. A method for protecting a substrate material from consumption by fire or significant damage by intense heat according to claim 23, wherein all structural metallic substrate surfaces are covered with the fire protection coating composition to a dry film thickness of 120 mils or more.
